(19) United States
(12) Patent Application Publication
(10) Pub. No.: US 2023/0102173 A1
(43) Pub. Date: Mar. 30, 2023

(54) INFORMATION PROCESSING METHOD, INFORMATION PROCESSING APPARATUS, AND INFORMATION PROCESSING PROGRAM

(71) Applicant: NIPPON TELEGRAPH AND TELEPHONE CORPORATION, Tokyo (JP)

(72) Inventors: Toshiro NAKAHIRA, Musashino-shi, Tokyo (JP); Hirantha ABEYSEKERA, Musashino-shi, Tokyo (JP); Koichi ISHIHARA, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 17/911,360

(22) PCT Filed: Mar. 17, 2020
(86) PCT No.: PCT/JP2020/011782

§ 371 Date: Sep. 13, 2022

(51) Int. Cl. H04W 24/10; H04B 17/318

(52) U.S. Cl. CPC H04W 24/10; H04B 17/318

(57) ABSTRACT

According to an information processing method of associating a plurality of base stations serving as transmission sources with pieces of information of beacons in a one-to-one manner, the beacons being transmitted by the plurality of base stations in an environment in which cells of the plurality of base stations overlap each other and measured at a plurality of measurement locations, the method includes performing first processing of associating an MAC address and a signal intensity of a beacon transmitted by one or more of the base stations with each of the measurement locations, performing second processing of associating, as a transmission source candidate of the beacon, one or more of the base stations located around each of the measurement locations that have undergone the first processing with the measurement location in ascending order of distance to the measurement location, performing third processing of associating one of the base stations closest to each of the measurement locations as a transmission source with the MAC address of the beacon having a strongest signal intensity after the second processing is performed, excluding the associated MAC address and base station after the second processing is performed, and associating one of the base stations closest to each of the measurement locations as a transmission source with the MAC address of the beacon having a strongest signal intensity.

### TECHNICAL FIELD

The present disclosure relates to an information processing method, an information processing apparatus, and an information processing program.

### BACKGROUND ART

Examples of radio communication systems using radio waves in the 2.4 GHz and 5 GHz band include those based on the IEEE 802.11a standard and IEEE 802.11g standard. Here, characteristics of the communication systems in multipath fading environments can be stabilized by using the modulation scheme of orthogonal frequency division multiplexing (OFDM), and thus a maximum transmission rate of 54 Mbit/s can be achieved.

In addition, in a radio communication system based on the IEEE 802.11n standard, a multiple-input multiple-output (MIMO) scheme in which a plurality of antennas are used to perform space division multiplexing on an identical radio channel and a channel bonding technique in which two 20 MHz frequency channels are simultaneously used as a 40 MHz frequency channel are used in the 2.4 GHz or 5 GHz band, and thus a maximum transmission rate of 600 Mbit/s can be achieved.

Further, in a radio communication system based on the IEEE 802.11ac standard, a channel bonding technique in which eight 20 MHz frequency channels are simultaneously used as a 160 MHz frequency channel at maximum, a multi-user MIMO technique in which different signals are simultaneously transmitted to a plurality of destinations on the same radio channel, and the like are used in the 5 GHz band to achieve faster and more efficient radio communication compared to that based on the IEEE 802.11n standard (e.g., see NPL 1).

Moreover, there is a technique in which radio communication is made possible within a predetermined area (coverage area) by installing a plurality of base stations whose cells overlap cells of other base stations. In this case, in order to check the reception intensity and tune radio parameters of radio waves transmitted from each of the base stations at a plurality of locations in the coverage area, an operator measures signal intensities while moving in the coverage area while carrying a signal measurement device.

When a signal intensity is measured, information of a beacon transmitted by a base station and information of the location at which the signal intensity is measured are included in the measurement results. The beacon includes an MAC address unique to the base station. Thus, the signal measurement device can distinguish beacons from one another even when it receives different beacons from a plurality of base stations.

### CITATION LIST

### Non Patent Literature

NPL 1: IEEE Standard for Information Technology—Telecommunications and Information Exchange between Systems Local and Metropolitan Area Networks-Specific Requirements, Part 11: Wireless LAN Medium Access Control (MAC) and Physical Layer (PHY) Specifications, IEEE Std 802.11-2016, December 2016.

### SUMMARY OF THE INVENTION

### Technical Problem

However, when receiving different beacons from a plurality of base stations at a predetermined location, an operator separately investigates the MAC addresses of the beacons transmitted from the base stations in order to identify which base station has transmitted which beacons and associate the MAC addresses with the base stations in a one-to-one manner, which is a problem due to the time and effort required.

An object of the present disclosure is to provide an information processing method, an information processing apparatus, and an information processing program that enable a plurality of base stations serving as a transmission source to be readily associated with pieces of information of beacons in a one-to-one manner, the beacons being transmitted by the plurality of base stations in an environment in which cells of the plurality of base stations overlap each other and measured at a plurality of measurement locations.

### Means for Solving the Problem

An information processing method according to an aspect of the present disclosure is an information processing method of associating a plurality of base stations serving as transmission sources with pieces of information of beacons in a one-to-one manner, the beacons being transmitted by the plurality of base stations in an environment in which cells of the plurality of base stations overlap each other and measured at a plurality of measurement locations, the information processing method including a first processing step of performing first processing of associating an MAC address and a signal intensity of a beacon transmitted by one or more of the base stations with each of the measurement locations, a second processing step of performing second processing of associating, as a transmission source candidate of the beacon, one or more of the base stations located around each of the measurement locations that have undergone the first processing in the first processing step with the measurement location in ascending order of distance to the measurement location, a third processing step of performing third processing of associating one of the base stations closest to each of the measurement locations as a transmission source with the MAC address of the beacon having a strongest signal intensity after the second processing is performed in the second processing step, and a control step of performing control such that, after the second processing is performed in the second processing step, the MAC address and the base station associated in the third processing step are excluded, and the third processing of associating one of the base stations closest to each of the measurement locations as a transmission source with the MAC address of the beacon having a strongest signal intensity is repeated.

In addition, an information processing apparatus according to an aspect of the present disclosure is an information processing apparatus that associates a plurality of base stations serving as transmission sources with pieces of information of beacons in a one-to-one manner, the beacons being transmitted by the plurality of base stations in an environment in which cells of the plurality of base stations overlap each other and measured at a plurality of measurement locations, the information processing apparatus including a first processing unit that performs first processing of associating an MAC address and a signal intensity of a beacon transmitted by one or more of the base stations with each of the measurement locations, a second processing unit that performs second processing of associating, as a transmission source candidate of the beacon, one or more of the base stations located around each of the measurement locations that have undergone the first processing performed by the first processing unit with the measurement location in ascending order of distance to the measurement location, a third processing unit that performs third processing of associating one of the base stations closest to each of the measurement locations as a transmission source with the MAC address of the beacon having a strongest signal intensity after the second processing is performed by the second processing unit, and a control unit that performs control such that, after the second processing is performed by the second processing unit, the MAC address and the base station associated by the third processing unit are excluded, and the third processing of associating one of the base stations closest to each of the measurement locations as a transmission source with the MAC address of the beacon having a strongest signal intensity is performed by the third processing unit.

### Effects of the Invention

According to the present disclosure, it is possible to associate a plurality of base stations serving as transmission sources with pieces of information of beacons in a one-to-one manner, the beacons being transmitted by the plurality of base stations in an environment in which cells of the plurality of base stations overlap each other and measured at a plurality of measurement locations.

### BRIEF DESCRIPTION OF DRAWINGS

FIG. 1 is a diagram illustrating an exemplary configuration of a radio communication system according to an embodiment.

FIG. 2 is a diagram schematically illustrating locations of base stations disposed in a coverage area.

FIG. 3 is a diagram schematically illustrating measurement locations at which intensities of radio waves transmitted by the base stations in the coverage area are measured.

FIG. 4 is a functional block diagram illustrating functions of an information processing apparatus according to an embodiment.

FIG. 5 is a diagram illustrating processing results of first processing performed by a first processing unit.

FIG. 6 is a diagram illustrating processing results of second processing performed by a second processing unit.

FIG. 7 is a flowchart illustrating exemplary information processing performed by the information processing apparatus.

FIG. 8(a) is a diagram illustrating a first step of information processing performed by the information processing apparatus. FIG. 8(b) is a diagram illustrating a second step of the information processing performed by the information processing apparatus. FIG. 8(c) is a diagram illustrating a third step of the information processing performed by the information processing apparatus.

FIG. 9 is a diagram illustrating an exemplary hardware configuration of the information processing apparatus according to an embodiment.

### DESCRIPTION OF EMBODIMENTS

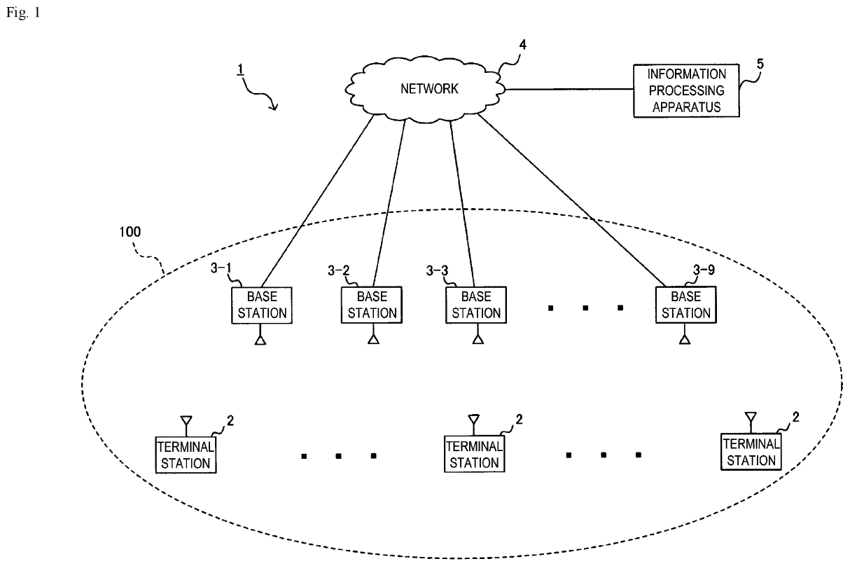

Hereinafter, an embodiment of a radio communication system will be described with reference to the accompanying drawings. FIG. 1 is a diagram illustrating an exemplary configuration of a radio communication system 1 according to an embodiment. As illustrated in FIG. 1, the radio communication system 1 includes, for example, nine base stations 3-1 to 3-9 to which a plurality of terminal stations 2 can be connected by radio, and an information processing apparatus 5 connected to a network 4. Further, unless any of a plurality of constituent components such as the base stations 3-1 to 3-9 is specified, they will be abbreviated simply as, for example, a base station 3.

The terminal stations 2 are radio communication terminals and perform radio communication with the base stations 3. Here, the terminal stations 2 are assumed to also have the function as the signal measurement device described above. For example, the terminal stations 2 are assumed to have a signal intensity measurement function of measuring a signal intensity of a beacon transmitted by each base station 3, a global positioning system (GPS) function of acquiring the longitude and latitude of the location at which the beacon has been received as a signal intensity measurement location, and a function of acquiring a media access control address (MAC address) included in the beacon.

The base stations 3-1 to 3-9 are installed such that the cell of each base station 3 overlaps the cells of other base stations 3, and are connected to the network 4. At this time, at least one of the base stations 3-1 to 3-9 is capable of performing radio communication with the terminal stations 2 located in a predetermined area (coverage area) 100. Furthermore, the base stations 3-1 to 3-9 are capable of receiving, from each of the terminal stations 2, a signal intensity measured by the terminal station 2 and the acquired measurement location and MAC address.

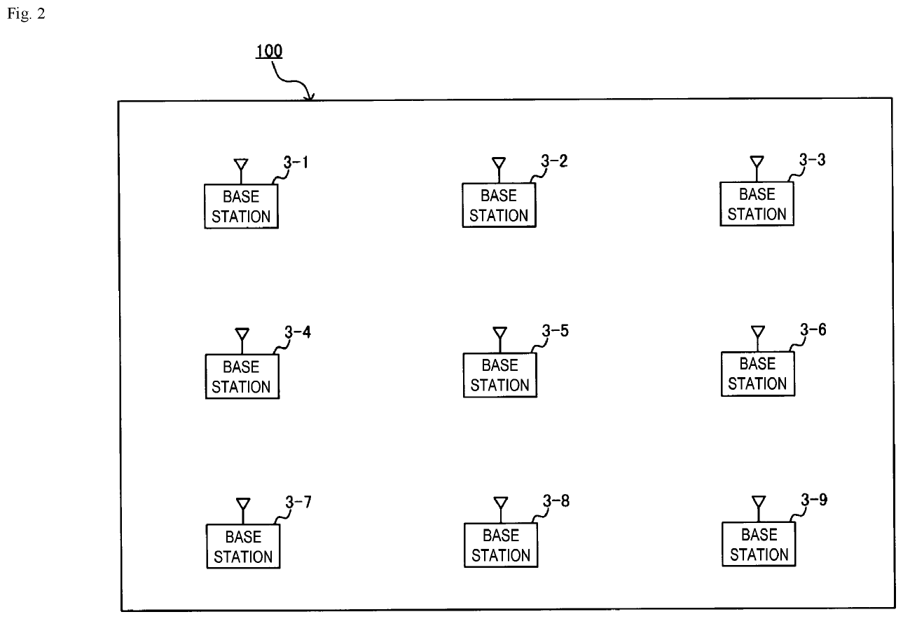

FIG. 2 is a diagram schematically illustrating locations of the base stations 3-1 to 3-9 disposed in the coverage area 100. As illustrated in FIG. 2, the base stations 3-1 to 3-9 are disposed at predetermined intervals from each other within a predetermined range to form the coverage area 100. Here, each of the base stations 3-1 to 3-9 may not have the same performance, such as a transmission power, and shapes and sizes of the cells are not assumed to be the same.

In addition, it is assumed that the location at which each of the base stations 3-1 to 3-9 is installed is pre-stored in the information processing apparatus 5 as base station location information including, for example, its longitude and latitude. Further, information in which each base station 3 is associated with base station location information of the base station 3 is defined as base station identification information.

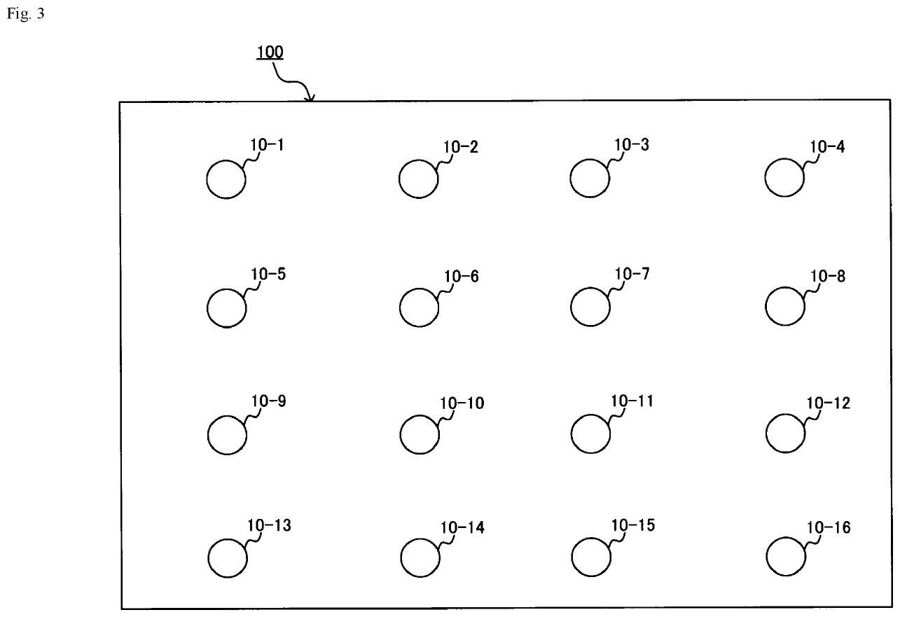

FIG. 3 is a diagram schematically illustrating measurement locations 10-1 to 10-16 at which intensities of radio waves transmitted by the base stations 3-1 to 3-9 in the coverage area 100 are measured. As illustrated in FIG. 3, the terminal stations 2, for example, receive beacons transmitted by the base stations 3 at the 16 measurement locations 10-1 to 10-16 spaced apart at predetermined intervals in the coverage area 100. Then, the terminal station 2 transmits the measured signal intensity and the acquired measurement location and MAC address to an accessible one of the base stations 3. Further, the measurement locations 10-1 to 10-16 are not limited as long as they are within the coverage area 100.

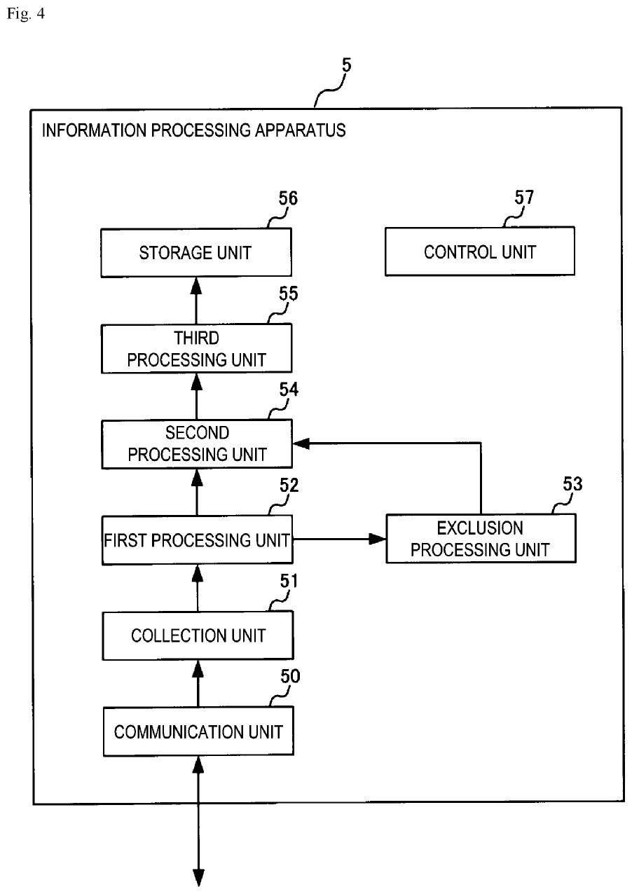

Next, functions of the information processing apparatus 5 will be described. FIG. 4 is a functional block diagram illustrating functions of the information processing apparatus 5 according to the embodiment. The information processing apparatus 5 includes, for example, a communication unit 50, a collection unit 51, a first processing unit 52, an exclusion processing unit 53, a second processing unit 54, a third processing unit 55, a storage unit 56, and a control unit 57 as illustrated in FIG. 4.

Further, the information processing apparatus 5 associates pieces of beacon information indicated by beacons with the base stations 3 serving as the transmission sources in a one-to-one manner, the beacons being transmitted by the plurality of base stations 3 whose cells overlap the cells of other base stations 3 and measured at a plurality of measurement locations.

Specifically, the communication unit 50 is a communication interface on which the information processing apparatus communicates with each of the base stations 3-1 to 3-9 via the network 4.

The collection unit 51 collects the signal intensities, measurement locations, and MAC addresses received by the base stations 3-1 to 3-9 from the terminal stations 2 via the communication unit 50, and outputs the collected information to the first processing unit 52.

The first processing unit 52 performs first processing of associating the MAC addresses and the signal intensities of the beacons transmitted by one or more of the base stations 3 with each of the measurement locations 10-1 to 10-16, and outputs the processing results to the exclusion processing unit 53 and the second processing unit 54.

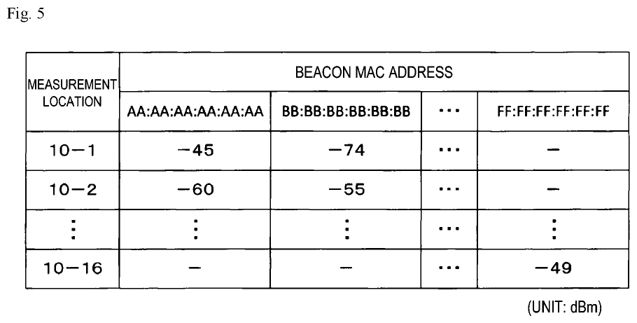

FIG. 5 is a diagram illustrating processing results of the first processing performed by the first processing unit 52. The first processing unit 52 associates a signal intensity of each of the beacon MAC addresses of the beacons with each of the measurement locations 10-1 to 10-16 as illustrated in FIG. 5.

Furthermore, the first processing unit 52 may perform the first processing of associating a piece of identification information different from the MAC address included in the beacon with each of the measurement locations 10-1 to 10-16. Further, the identification information may include information identifying, for example, the function or performance of the base station 3, or the manufacturer.

The exclusion processing unit 53 (FIG. 4) performs exclusion processing of excluding any of the base stations 3 from candidates (transmission source candidates) determined to be the transmission source of the beacon based on the identification information input from the first processing unit 52, and outputs the processing results to the second processing unit 54.

The second processing unit 54 performs second processing based on the processing results input from the first processing unit 52, and outputs the processing results to the third processing unit 55. Specifically, the second processing unit 54 performs second processing in which one or more of the base stations 3 located around each of the measurement locations 10-1 to 10-16 that have undergone the first processing by the first processing unit 52 are associated as transmission source candidates of the beacon with the measurement location in ascending order of distance.

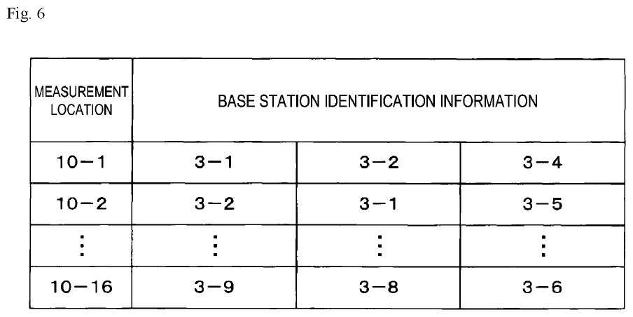

FIG. 6 is a diagram illustrating processing results of the second processing performed by the second processing unit 54. As illustrated in FIG. 6, the second processing unit 54 associates, for example, three of the base stations 3 located around each of the measurement locations 10-1 to 10-16 with the measurement location in ascending order of distance between the measurement location 10 and the base stations 3 serving as transmission source candidates of the beacons.

It is assumed in the base station identification information of FIG. 6 that each of the base stations 3-1 to 3-9 is associated with corresponding pieces of the base station location information. Furthermore, in FIG. 6, the base stations 3 are described from the left in ascending order of distance from the measurement location 10 based on the base station location information.

In addition, after the exclusion processing unit 53 performs the exclusion processing, the second processing unit 54 performs the second processing based on the results from the exclusion processing performed by the exclusion processing unit 53.

The third processing unit 55 performs third processing of associating the base station closest to each measurement location as a transmission source with the MAC address of the beacon having the strongest signal intensity after the second processing unit 54 performs the second processing, and causes the storage unit 56 to store the processing results.

The storage unit 56 stores, for example, the base station location information including longitude and latitude and data processed in the information processing apparatus 5 and allows the control unit 57 to access them.

The control unit 57 controls each unit constituting the information processing apparatus 5. For example, after the second processing unit 54 performs the second processing, the information processing apparatus 5 performs control such that the MAC addresses and base stations 3 associated by the third processing unit 55 are excluded, and the third processing unit 55 performs the third processing of associating the base station 3 closest to each measurement location as a transmission source with the MAC address of the beacon having the strongest signal intensity.

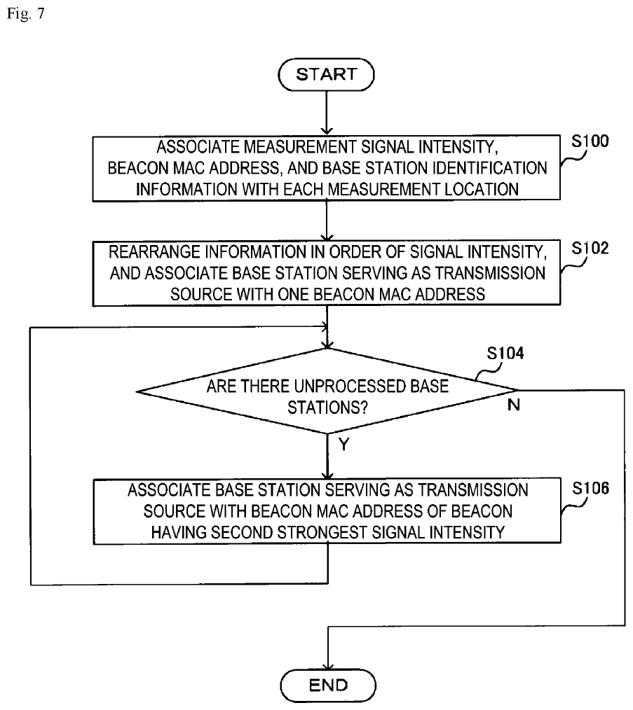

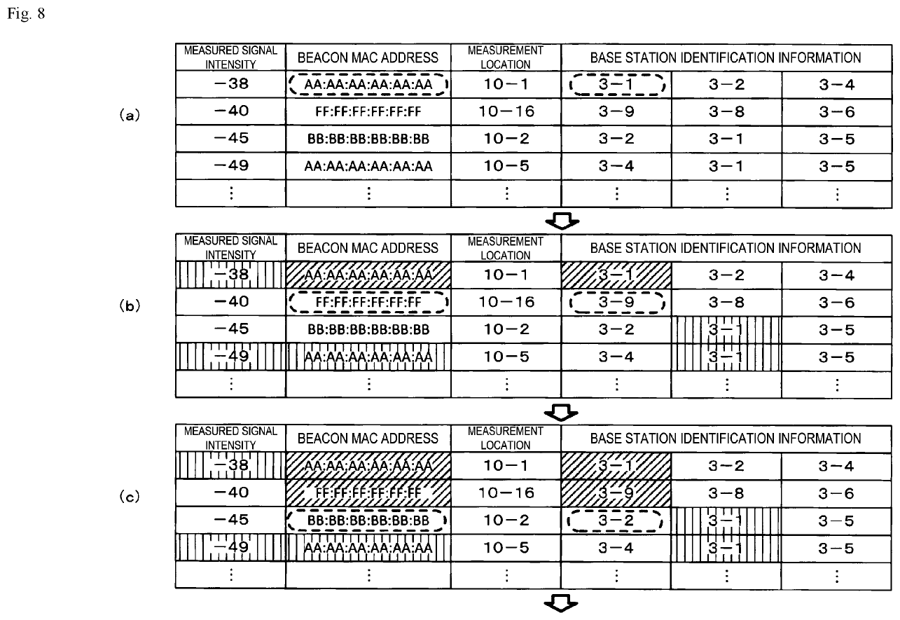

Next, exemplary information processing performed by the information processing apparatus 5 will be described using FIGS. 7 and 8. FIG. 7 is a flowchart illustrating exemplary information processing performed by the information processing apparatus 5. FIG. 8 are diagrams illustrating steps of the information processing performed by the information processing apparatus 5. FIG. 8(a) is a diagram illustrating a first step of the information processing performed by the information processing apparatus 5. FIG. 8(b) is a diagram illustrating a second step of the information processing performed by the information processing apparatus 5. FIG. 8(c) is a diagram illustrating a third step of the information processing performed by the information processing apparatus 5.

The information processing apparatus 5 first associates the MAC address of the beacon having the strongest signal intensity (beacon MAC address), the measured signal intensity of the beacon (measured signal intensity), and the base station identification information of three of the base stations 3 serving as transmission source candidates of the beacon with each measurement location 10 in ascending order of distance to the measurement locations 10 (S100) as illustrated in FIG. 7.

Next, the information processing apparatus 5 rearranges the pieces of the information associated in the processing of S100 in order of signal intensities for each measurement location 10, and associates a base station serving as the transmission source with one beacon MAC address (S102).

For example, as illustrated in FIG. 8(a), the information processing apparatus 5 associates the base station 3-1 with the shortest distance to the measurement location 10 as a base station serving as a transmission source among the three base stations 3 serving as the transmission source candidates with the beacon MAC address (AA: AA: AA: AA: AA: AA) of the beacon having the strongest signal intensity.

Next, the information processing apparatus 5 determines whether there is a base station 3 that has not undergone the processing of associating the beacon MAC addresses with the base stations 3 in the radio communication system 1 (S104). If there is an unprocessed base station 3 (S104: Yes), the information processing apparatus 5 proceeds to the processing of S106, and if there are no unprocessed base stations 3 (S104: No), the information processing apparatus 5 terminates the processing.

In the processing of S106, the information processing apparatus 5 associates another base station 3 serving as a transmission source with the beacon MAC address of the beacon having the second strongest signal intensity, and returns to the processing of S104.

For example, as illustrated in FIG. 8(b), the information processing apparatus 5 associates the base station 3-9 in the shortest distance to the measurement location 10 as a base station serving as the transmission source among the three base stations 3 serving as the transmission source candidates with the beacon MAC address (FF: FF: FF: FF: FF: FF) of the beacon having the second strongest signal intensity.

At this time, as illustrated in FIG. 8(b), the information processing apparatus 5 excludes the beacon MAC address (AA: AA: AA: AA: AA: AA) and the base station 3-1 that have already been associated with each other from processing targets.

In addition, if there is an unprocessed base station 3, the information processing apparatus 5 associates the base station 3-2 in the shortest distance to the measurement location 10 as a base station serving as the transmission source among the three base stations 3 serving as the transmission source candidates with the beacon MAC address (BB: BB: BB: BB: BB: BB) of the beacon having the third strongest signal intensity, for example, as illustrated in FIG. 8(c).

At this time, as illustrated in FIG. 8(c), the information processing apparatus 5 excludes the beacon MAC addresses (AA: AA: AA: AA: AA: AA, and BB: BB: BB: BB: BB: BB) and the base stations 3-1 and 3-9 that have already been associated with each other from processing targets.

Further, in a case in which the information processing apparatus 5 distinguishes the plurality of beacons received at the measurement location 10 using the above-described identification information, the exclusion processing unit 53 excludes a beacon that is not a target and performs the information processing illustrated in FIG. 7.

In this manner, the radio communication system 1 associates, for each measurement location 10, the base station 3 closest to the measurement location 10 as a transmission source with the MAC address of the beacon having the strongest signal intensity. Thus, beacon information indicated by the beacons measured at the plurality of measurement locations 10 can be readily associated with the base stations 3 serving as transmission sources in a one-to-one manner.

Further, some or all of the functions of the terminal stations 2, the base stations 3, and the information processing apparatus 5 may be configured by hardware such as a programmable logic device (PLD) or a field programmable gate array (FPGA), or by a program executed by a processor such as a CPU.

The information processing apparatus 5 according to the present disclosure can also be achieved by, for example, a computer and a program, and the program can be recorded in a storage medium or can be provided through a network.

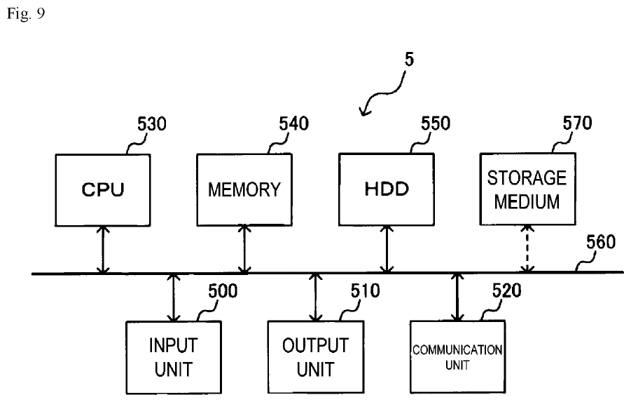

FIG. 9 is a diagram illustrating an exemplary hardware configuration of the information processing apparatus 5 according to an embodiment. As illustrated in FIG. 9, the information processing apparatus 5 includes, for example, an input unit 500, an output unit 510, a communication unit 520, a CPU 530, a memory 540, and an HDD 550 connected via a bus 560, and functions as a computer. In addition, the information processing apparatus 5 is capable of exchanging data with a computer-readable storage medium 570.

Examples of the input unit 500 include a keyboard and a mouse. Examples of the output unit 510 include a display device such as a display. Examples of the communication unit 520 include a wired network interface.

The CPU 530 controls each unit constituting the information processing apparatus 5 and performs predetermined processing and the like. The memory 540 and the HDD 550 constitute a storage unit that stores data. In particular, the memory 540 stores data to be used in the above-described processing. The storage medium 570 is capable of storing a communication control program and the like for implementing the functions of the information processing apparatus 5. Further, the architecture of the information processing apparatus 5 is not limited to the example illustrated in FIG. 9.

In other words, the “computer” mentioned here is assumed to include an OS and hardware such as a peripheral device. In addition, the “computer-readable storage medium” refers to a storage device such as a portable medium such as a flexible disk, a magneto-optical disc, a ROM, and a CD-ROM.

Moreover, the “computer-readable storage medium” may include a recording medium that dynamically holds a program for a short period of time, such as a communication line in a case in which the program is transmitted via a network such as the Internet or a telephone line, or a recording medium that holds the program for a specific period of time, such as a volatile memory inside a computer that serves as a server or a client in that case.

Although the embodiments of the present disclosure have been described above with reference to the drawings, it is apparent that the embodiment described above is a mere example of the present disclosure, and the present disclosure is not limited to the embodiment described above. Thus, addition, omission, substitution, and other modifications of the constituent components may be made without departing from the technical spirit and scope of the present disclosure.

### REFERENCE SIGNS LIST

1 Radio communication system
2 Terminal station
3-1 to 3-9 Base station
4 Network
5 Information processing apparatus
10-1 to 10-16 Measurement location
50 Communication unit
51 Collection unit
52 First processing unit
53 Exclusion processing unit
54 Second processing unit
55 Third processing unit
56 Storage unit
57 Control unit
100 Coverage area
500 Input unit
510 Output unit
520 Communication unit
530 CPU
540 Memory
550 HDD
560 Bus
570 Storage medium

1. An information processing method of associating a plurality of base stations serving as transmission sources with pieces of information of beacons in a one-to-one manner, the beacons being transmitted by the plurality of base stations in an environment in which cells of the plurality of base stations overlap each other and measured at a plurality of measurement locations, the information processing method comprising:
a first processing step of performing first processing of associating an MAC address and a signal intensity of a beacon transmitted by one or more of the base stations with each of the measurement locations;
a second processing step of performing second processing of associating, as a transmission source candidate of the beacon, one or more of the base stations located around each of the measurement locations that have undergone the first processing in the first processing step with the measurement location in ascending order of distance to the measurement location;
a third processing step of performing third processing of associating one of the base stations closest to each of the measurement locations as a transmission source with the MAC address of the beacon having a strongest signal intensity after the second processing is performed in the second processing step; and
a control step of performing control such that, after the second processing is performed in the second processing step, the MAC address and the base station associated in the third processing step are excluded, and the third processing of associating one of the base stations closest to each of the measurement locations as a transmission source with the MAC address of the beacon having a strongest signal intensity is repeated.

2. The information processing method according to claim 1, wherein
the first processing step includes performing the first processing of further associating identification information that is different from the MAC address included in the beacon with each of the measurement locations,
the information processing method further comprises an exclusion processing step of performing exclusion processing of excluding one of the base stations identified based on the identification information from the transmission source candidate of the beacon, and
the second processing step includes performing the second processing after the exclusion processing is performed in the exclusion processing step.

3. An information processing apparatus configured to associate a plurality of base stations serving as transmission sources with pieces of information of beacons in a one-to-one manner, the beacons being transmitted by the plurality of base stations in an environment in which cells of the plurality of base stations overlap each other and measured at a plurality of measurement locations, the information processing apparatus comprising:
a first processing unit configured to perform first processing of associating an MAC address and a signal intensity of a beacon transmitted by one or more of the base stations with each of the measurement locations;
a second processing unit configured to perform second processing of associating, as a transmission source candidate of the beacon, one or more of the base stations located around each of the measurement locations that have undergone the first processing performed by the first processing unit with the measurement location in ascending order of distance to the measurement location;
a third processing unit configured to perform third processing of associating one of the base stations closest to each of the measurement locations as a transmission source with the MAC address of the beacon having a strongest signal intensity after the second processing is performed by the second processing unit; and
a control unit configured to perform control such that, after the second processing is performed by the second processing unit, the MAC address and the base station associated by the third processing unit are excluded, and the third processing of associating one of the base stations closest to each of the measurement locations as a transmission source with the MAC address of the beacon having a strongest signal intensity is performed by the third processing unit.

4. The information processing apparatus according to claim 3, wherein
the first processing unit performs the first processing of further associating identification information that is different from the MAC address included in the beacon with each of the measurement locations,
the information processing apparatus further comprises an exclusion processing unit configured to perform exclusion processing of excluding one of the base stations identified based on the identification information from the transmission source candidate of the beacon, and
the second processing unit performs the second processing after the exclusion processing unit performs the exclusion processing.

5. An information processing program for causing a computer to operate as each unit of the information processing apparatus according to claim 3.
